(19) United States
(12) Patent Application Publication
(10) Pub. No.: US 2025/0309627 A1
(43) Pub. Date: Oct. 2, 2025

(54) UNDERGROUND ENCLOSURE WITH REMOTE POWER

(71) Applicant: Hubbell Incorporated, Shelton, CT (US)

(72) Inventors: Robert W. Fox, Greenback, TN (US); Scott Ryan Venczel, Knoxville, TN (US); Jalil Khateeb Thompson, Knoxville, TN (US); John T. Polk, III, Lenoir City, TN (US); Samuel Thomas Melton, Knoxville, TN (US); Ronald Melcher, Loudon, TN (US); Timothy Alexander, Loudon, TN (US)

(21) Appl. No.: 19/092,133

(22) Filed: Mar. 27, 2025

Related U.S. Application Data
(60) Provisional application No. 63/571,091, filed on Mar. 28, 2024.
(60) Provisional application No. 63/755,649, filed on Feb. 7, 2025.

(51) Int. Cl. H02G 3/18; H02G 3/08

(52) U.S. Cl. CPC H02G 3/18; H02G 3/088

(57) ABSTRACT

An underground enclosure system includes an underground enclosure, a ground-fault circuit interrupter (GFCI), and an electrical outlet. The underground enclosure includes a base with a first wall that at least partially defines an internal volume. The wall includes a lip that extends into the internal volume. A lid is coupled to the base to at least partially enclose the volume. The lid can contact the lip and be received at least partially within the internal volume. The GFCI is disposed within the base and can receive electrical power. The electrical outlet is in electrical communication with the GFCI. The electrical outlet is positioned downstream from the GFCI. The electrical outlet can connect to an external electrical device and provide power to the external electrical device.

### CROSS-REFERENCE TO RELATED APPLICATIONS

This application claims the benefit of U.S. Provisional Application No. 63/755,649, filed Feb. 7, 2025, and U.S. Provisional Application No. 63/571,091, filed Mar. 28, 2024, the entire contents of each are incorporated herein by reference in their entirety.

### FIELD

The present disclosure relates to an enclosure for an electrical device. More particularly, the present disclosure relates to a commercially rated outdoor electrical enclosure.

### BACKGROUND

Enclosures may be installed in various locations to provide access to electrical power. Generally, these enclosures may be installed away from an outlet in buildings or other structures as a way to provide electrical power in remote locations (e.g., without the need for an extension cord that reaches a building or the use of a remote generator).

These enclosures may be installed outside and are generally weather resistant and are generally designed to limit or prevent liquid from reaching the electrical devices housed within. For example, liquid may be able to enter the enclosure, but the enclosure's geometry and/or the position of the electrical devices may minimize contact with liquid. One such example is a bell jar design, which orients the electrical elements so that if water enters the enclosure, it is unable to reach the electrical device.

Additionally, typical enclosures may be constructed from a material that is sufficient to withstand only low levels of weight. For example, an enclosure may be constructed from a plastic material, which may be selected as an inexpensive material. However, this material may limit where the enclosure may be installed. For example, the plastic material may be able to support pedestrian traffic or light vehicular traffic (e.g., lawn mowers). However, these materials may be unable to support the weight of larger vehicular traffic (e.g., cars, trucks, heavy machinery, etc.). These enclosures may be unable to be installed near roadways, or other locations frequented by these machines, because there is a substantial risk that they may fail when attempting to support the weight.

### SUMMARY

Various examples of the present disclosure can overcome various of the aforementioned and other disadvantages associated with known underground enclosures and offer new advantages as well.

According to one aspect of various examples of the present disclosure there is provided an underground enclosure constructed from a material sufficient to support a load.

According to one aspect of various examples of the present disclosure there is provided an underground enclosure constructed from a material sufficient to support a pedestrian load.

According to one aspect of various examples of the present disclosure there is provided an underground enclosure constructed from a material sufficient to support a vehicular load.

According to one aspect of various examples of the present disclosure there is provided an enclosure constructed from polymer concrete that can house one or more electrical elements.

According to one aspect of various examples of the present disclosure there is provided an enclosure housing a GFCI in electrical communication with an electrical outlet.

According to one aspect of various examples of the present disclosure there is provided an underground enclosure that houses an electrical enclosure. The electrical enclosure is sealed and prevents liquid from entering the electrical enclosure that has entered the underground enclosure.

According to one aspect of various examples of the present disclosure there is provided an underground enclosure that houses an electrical device. The underground enclosure can permit the ingress of liquid and the electrical device within the enclosure is a shore-rated device that is water-resistant.

According to one aspect of various examples of the present disclosure there is provided an enclosure that includes a lid coupled to a base in an unsealed orientation. A volume within the base houses an electrical device that can receive electrical power from a source. The electrical device is received within a housing that is sealed to prevent the ingress of liquid.

According to another aspect of various examples of the present disclosure, there is provided an underground enclosure system that includes an underground enclosure, an electrical enclosure, and a second electrical device.

According to another aspect of various examples of the present disclosure, there is provided an enclosure having a base and a lid. The lid includes a body and a door that is movable relative to the body. A single fastener can be used to connect the door and the body to the base.

According to another aspect of various examples of the present disclosure, there is provided an enclosure having a base and a lid. The lid includes a body and a door that is movable relative to the body. The door includes an opening than can receive an electrical cable to permit electrical connection to components within the base while the lid is in a closed position.

According to another aspect of various examples of the present disclosure, there is provide an enclosure having a base and a lid. A dividing wall extends across a portion of an interior volume of the base.

According to another aspect of various examples of the present disclosure, there is provided an underground enclosure system that includes an underground enclosure with an internal volume divided into a first section and a second section, an electrical plug for outputting a first voltage disposed in the first section, a communication plug disposed in the second section.

According to another aspect of various examples of the present disclosure, there is provided an underground enclosure system that includes an underground enclosure, an electrical splice contained within a waterproof material, and an electrical plug.

According to another aspect of various examples of the present disclosure, there is provided an underground enclosure system that includes an underground enclosure, a ground-fault circuit interrupter (GFCI), and an electrical outlet. The underground enclosure includes a base with a first wall that at least partially defines an internal volume. The wall includes a lip that extends into the internal volume. A lid is coupled to the base to at least partially enclose the volume. The lid can contact the lip and be received at least partially within the internal volume. The GFCI is disposed within the base and can receive electrical power. The electrical outlet is in electrical communication with the GFCI. The electrical outlet is positioned downstream from the GFCI. The electrical outlet can connect to an external electrical device and provide power to the external electrical device.

In some forms, a) the underground enclosure is constructed from a first material that is a polymer concrete; b) a first conduit is connected to the electrical enclosure in a sealing engagement; and/or c) the first conduit can convey an electrical conductor out of the electrical enclosure and toward the second electrical device.

In some forms, a) an electrical enclosure is disposed within the base and houses a first electrical device that receives electrical power from a source and transmits electrical power to the GFCI; b) the first electrical device is sealed and can prevent the ingress of liquid from the internal volume; c) the lid includes a first thickness and the lip is disposed a first distance from an upper end of the wall; d) the first thickness is equal to the first distance; e) the lid includes a body and a door that is movable relative to the body; f) the door can move from a closed position to an open position to expose the internal volume while the lid remains fixed to the base; and/or g) the GFCI is an in-line GFCI.

According to another aspect of various examples of the present disclosure, there is provided an underground enclosure system that includes an underground enclosure, an electrical enclosure, a second electrical device, and a ground-fault circuit interrupter (GFCI). The underground enclosure includes a base having a first wall that at least partially defines an internal volume. The electrical enclosure houses a first electrical device that receives electrical power from a source. The first electrical device is sealed and can prevent the ingress of liquid from the internal volume. The second electrical device is in electrical communication with the first electrical device. The second electrical device can connect to an external electrical device and provide power to the external electrical device. The GFCI is disposed within the base and electrically connected between the first electrical device and the second electrical device. A conduit carrying an electrical conductor extends between the electrical enclosure and the GFCI. The conduit is connected to the electrical enclosure in a sealing engagement.

In some forms, a) the second electrical device is removably received within a holder; b) the second electrical device can be removed from the base while remaining electrically connected to the first electrical device; c) the second electrical device is a shore-rated device; and/or d) the second electrical device can continue to provide power to the external electrical device contacting liquid.

In some forms, a) the underground enclosure is constructed from a first material that can support a load sufficient to support a vehicular load; b) the underground enclosure further includes a lid removably connected to the base to at least partially enclose the internal volume; c) in an enclosed position, the lid is received at least partially within the internal volume and a top surface of the lid is flush with a top surface of the base; d) the lid further includes a body and a door that is movable relative to the body; e) the lid connected to the base so that the door is proximate to the second electrical device and/or the GFCI; f) the door is configured to move relative to the body to expose the second electrical device and/or the GFCI; and/or g) the GFCI is an in-line GFCI.

According to another aspect of various examples of the present disclosure, there is provided an underground enclosure system that includes an underground enclosure, a first electrical device, a second electrical device, and a ground-fault circuit interrupter (GFCI). The underground enclosure includes a base having a first wall that at least partially defines an internal volume. The first electrical device can receive electrical power from a source. The first electrical device is spliced to an electrical conductor and sealed within a material that can prevent the ingress of liquid from the internal volume. The second electrical device is in electrical communication with the first electrical device. The second electrical device can connect to an external electrical device and provide power to the external electrical device. The GFCI is disposed within the base and electrically connected between the first electrical device and the second electrical device. A conduit carrying an electrical conductor extends between the electrical enclosure and the GFCI. The conduit is connected to the electrical enclosure in a sealing engagement.

In some forms, a) the second electrical device is removably received within a holder; b) the second electrical device can be removed from the base while remaining electrically connected to the first electrical device; c) the second electrical device is a shore-rated device; and/or d) the second electrical device can continue to provide power to the external electrical device contacting liquid.

In some forms, a) the underground enclosure is constructed from a first material that can support a load sufficient to support a vehicular load; b) the underground enclosure further includes a lid removably connected to the base to at least partially enclose the internal volume; c) in an enclosed position, the lid is received at least partially within the internal volume and a top surface of the lid is flush with a top surface of the base; d) the lid further includes a body and a door that is movable relative to the body; e) the lid connected to the base so that the door is proximate to the second electrical device and/or the GFCI; f) the door is configured to move relative to the body to expose the second electrical device and/or the GFCI; and/or g) the GFCI is an in-line GFCI.

In some forms, (a) the material is heat shrunk around the electrical conductor; (b) a divider wall separates the internal volume into a first section and a second section; (c) the second electrical device and the GFCI are disposed in the first section; (d) a third electrical device is disposed in the second section; and/or (e) the third electrical device can connect to a second external electrical device and provide power to the second external electrical device.

According to another aspect of various examples of the present disclosure, there is provided an underground enclosure, a ground-fault circuit interrupter (GFCI), and an electrical outlet. The underground enclosure includes a base having a first wall that at least partially defines an internal volume, and a lid connected to the base to at least partially enclose the volume. The connection between the base and the lid can permit the ingress of liquid. The GFCI is disposed within the base and can receive electrical energy. The electrical outlet is located downstream from and is in electrical communication with the GFCI. The electrical outlet can connect to an external electrical device and provide power to the external electrical device. The GFCI can stop the flow of electrical energy to the electrical outlet when the GFCI comes in contract with liquid. The underground enclosure is constructed from a first material that can support a vehicular load.

In some forms, a) an electrical enclosure is disposed within the base and houses a first electrical device that receives electrical power from a source and transmits electrical power to the GFCI; b) the first electrical device is sealed and can prevent the ingress of liquid from the internal volume; c) the first material is a polymer concrete; d) the lid includes a body and a door that is movable relative to the body; e) the door can move from a closed position to an open position to expose the internal volume while the lid remains fixed to the base; and/or f) the GFCI is an in-line GFCI.

In some forms, a) the second electrical device is removably received within a holder and can be removed from the base through an opening exposed by the door while remaining electrically connected to the first electrical device; b) a first conduit is connected to the electrical enclosure in a sealing engagement and can convey an electrical conductor out of the electrical enclosure and toward the second electrical device; c) the wall includes a lip that extends into the internal volume; d) in an enclosed position, the lid contacts the lip and is received at least partially within the internal volume; and/or e) a top surface of the lid is flush with a top surface of the base.

According to another aspect of various examples of the present disclosure, there is provided a method of installing an underground enclosure system. The method includes installing an enclosure having an interior volume at least partially underground. The method also includes feeding a first electrical conductor into the interior volume. The first electrical conductor can provide electrical energy from a source. The method further includes splicing a second electrical conductor to the first electrical conductor by heat-shrinking material around the splice. The second electrical conductor is connected to a ground-fault circuit interrupter (GFCI) disposed within the interior volume. Finally, the method includes connecting a lid to the enclosure to at least partially cover the interior volume.

In some forms, a) the underground enclosure is constructed from a first material that can support a vehicular load; b) the lid further includes a body and a door that is movable relative to the body; c) the method also includes moving the door relative to the lid while the lid remains coupled to the enclosure; and/or d) the GFCI is an in-line GFCI.

The disclosure herein should become evident to a person of ordinary skill in the art given the following enabling description and drawings. The drawings are for illustration purposes only and are not drawn to scale unless otherwise indicated. The drawings are not intended to limit the scope of the disclosure. The following enabling disclosure is directed to one of ordinary skill in the art and presupposes that those aspects within the ability of the ordinarily skilled artisan are understood and appreciated.

### BRIEF DESCRIPTION OF THE DRAWINGS:

Various aspects and advantageous features of the present disclosure will become more apparent to those of ordinary skill when described in the detailed description of preferred examples and reference to the accompany drawing wherein:

FIG. 1 is an exploded view of an enclosure housing one or more electrical devices.

FIG. 2 is a top view of the enclosure of FIG. 1 with the lid removed.

FIG. 3 is a cross-sectional view of the enclosure of FIG. 2, viewed along section 3-3.

FIG. 4 is a cross-sectional view of the enclosure of FIG. 2, viewed along section 4-4.

FIG. 5 is a perspective view of an electrical enclosure included in the enclosure housing of FIG. 1.

FIG. 6 is a perspective view of a ground-fault circuit interrupter (GFCI) supported by a cradle, which is included in the enclosure housing of FIG. 1.

FIG. 7 is a perspective view of a plug received within a plug clamp, which is included in the enclosure housing of FIG. 1.

FIG. 8 is a top view of the plug received within the plug clamp of FIG. 7.

FIG. 9 is an exploded view of an enclosure according to another example that houses one or more electrical devices.

FIG. 10 is a top view of the enclosure of FIG. 9 with the lid removed.

FIG. 11 is a cross-sectional view of the enclosure of FIG. 10, viewed along section 11-11.

FIG. 12 is a first exploded view of a lid used with the enclosure of FIG. 9.

FIG. 13 is a second exploded view of the lid of FIG. 12.

FIG. 14 is a top view of the lid of FIG. 12.

FIG. 15 is an exploded view of a first alternate enclosure housing one or more electrical devices.

FIG. 16 is a cross-sectional view of the enclosure of FIG. 15 viewed along section 16-16.

FIG. 17 is an exploded view of a second alternate enclosure housing one or more electrical devices.

FIG. 18 is a top view of the enclosure of FIG. 17.

FIG. 19 is a cross-sectional view of the enclosure of FIG. 15 viewed along section 19-19.

FIG. 20 is an exploded view of a third alternate enclosure housing one or more electrical devices.

FIG. 21 is a top view of the enclosure of FIG. 20.

FIG. 22 is a cross-sectional view of the enclosure of FIG. 20 viewed along section 22-22.

FIG. 23 is a cross-sectional view of the enclosure of FIG. 20 viewed along section 23-23.

FIG. 24 is a perspective view of a fourth alternate enclosure housing one or more electrical devices.

FIG. 25 is a detail view of the enclosure of FIG. 24, illustrating a connection between electrical connectors.

### DETAILED DESCRIPTION:

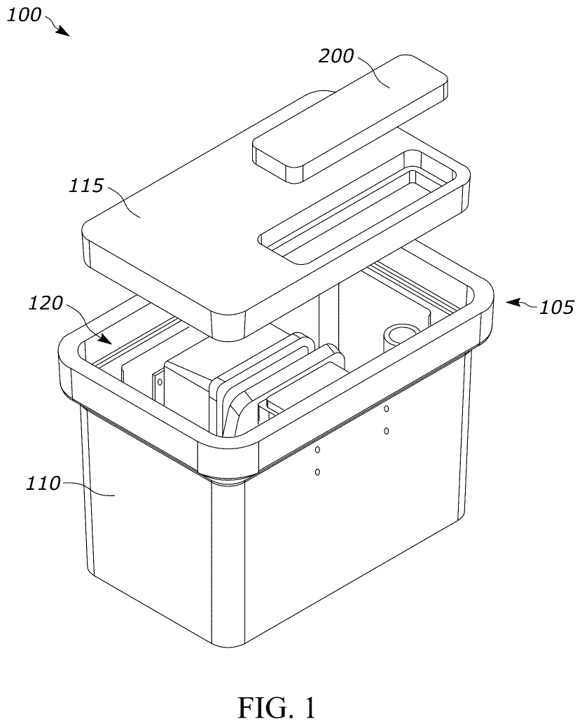

As shown in FIG. 1, an enclosure 100 may include an outer enclosure 105. The outer enclosure 105 may include a substantially rectangular shape, although any shape (e.g., a rounded or circular shape) may be used. As described in more detail below, the outer enclosure 105 may be used to support electrical components.

In some forms, the outer enclosure 105 includes a base 110 and a lid 115. The base 110 may include an internal volume 120 that can receive electrical components. The lid 115 may be movable between an open position that at least partially exposes the internal volume 120 and a closed position that at least partially encloses the internal volume.

In some forms, the base 110 and/or the lid 115 may be constructed from a rigid material. The material may be selected to withstand the weight of vehicular traffic without fracturing or otherwise failing. For example, the base 110 and/or the lid 115 may be constructed from a polymer concrete material, although other materials (e.g., other polymer materials) may be used. This material may be selected so that the enclosure 100 can receive an ANSI/SCTE 77 Tier 22 rating (e.g., may be used in off-roadway applications and support up to a class 8 vehicle). However, any material may be selected and the enclosure 100 may be designed to receive other ratings.

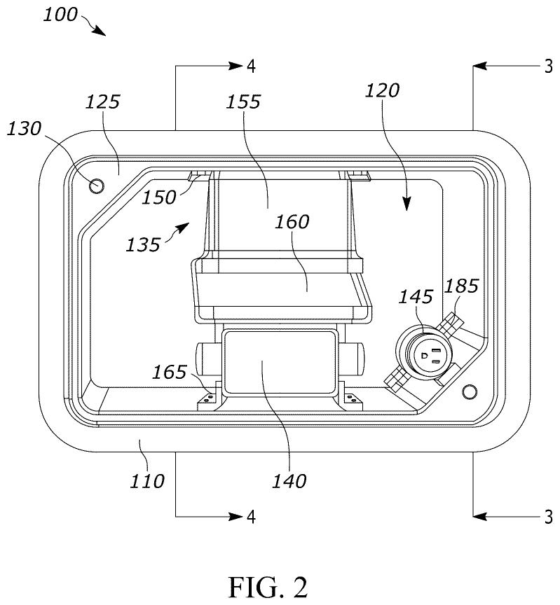

As shown in FIGS. 1 and 2, the base 110 may include an internal lip 125 positioned within the volume 120. The lip 125 may be formed proximate to an upper end of the base 110. For example, the lip 125 may be recessed within the volume 120 a distance that is approximately equal to a thickness of the lid 115.

In some forms, the lip 125 may extend around the entirety on the inner perimeter of the base 110. Although in other example, the lip 125 may extend around only a portion of the perimeter of the base 110.

As shown in FIG. 2, the lip 125 may include different widths along different portions of the perimeter. For example, the lip 125 may be wider in at least one corner of the base 110 than along the sides of the base 110. The illustrated example includes two corners of the lip 125 with an increased width, although any number of corners may include the increased width.

In certain forms, the corners of the lip 125 with the increased width may include an aperture 130 that may extend through the surface of the lip 125. As described in more detail below, each aperture 130 may receive a fastener for securing the lid 115 to the base 110. The fastener may be a hex bolt (or any similar standard fastener) or the fastener may be a tamper-resistant fastener to limit unauthorized access to the internal volume 120.

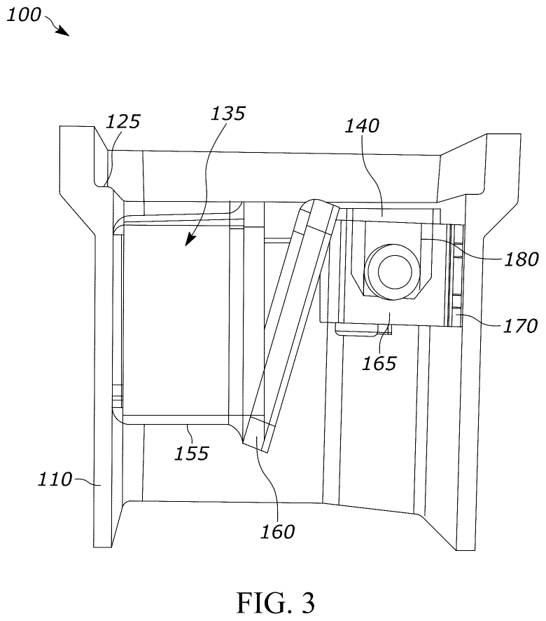

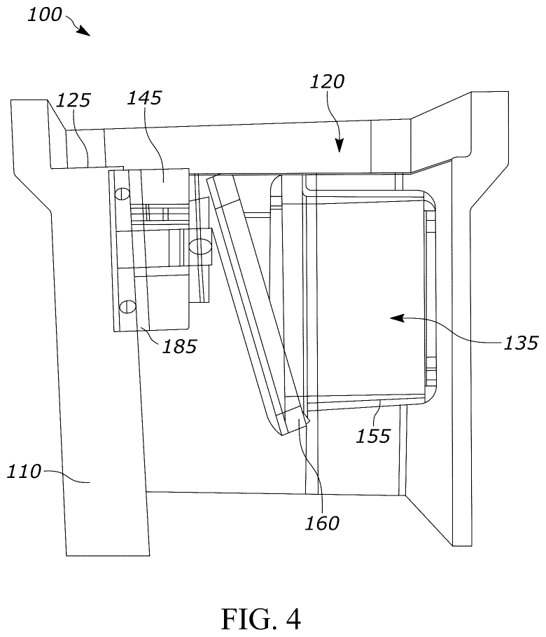

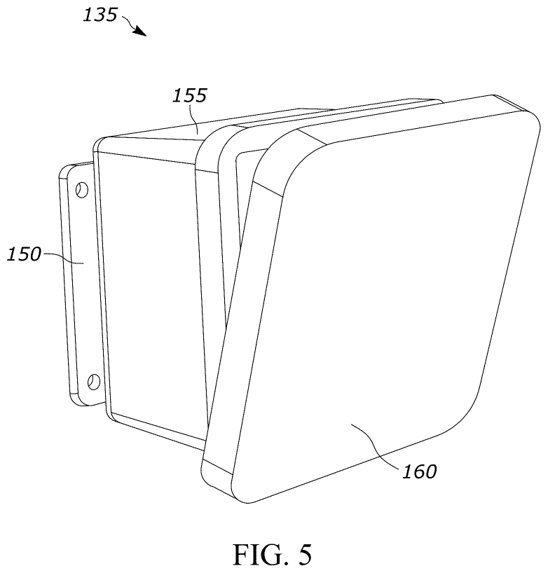

As shown in FIGS. 3 and 4, one or more electrical devices may be received within the internal volume 120 of the base 110. For example, the one or more electrical devices may be secured to a wall of the base 110 within the internal volume 120. The illustrated example may include three electrical devices: an electrical box 135, a ground-fault circuit interrupter (GFCI) 140, and a plug 145. Although other examples may include a different number of electrical devices.

In some forms, the electrical box 135 may be an enclosure received within the volume 120 of the base 110. For example, the electrical box 135 may be secured to an inner wall of the base 110. In the illustrated example, the electrical box 135 may include a bracket 150 (e.g., formed in one piece). Although other examples may include a separate bracket 150 that connects the electrical box 135 to the base 110.

The electrical box 135 may include an electrical base 155 and a top 160. The bracket 150 may be formed integrally with the base 155 so that a surface of the base 155 is positioned against a wall of the enclosure 100. The base 155 may include an opening that is oriented away from the wall of the base 110. The opening may be covered by the top 160 to enclose the volume within the base 155.

In some forms, the top 160 may be connected to the base 155 to seal the volume within the electrical box 135. For example, there may be a water-tight seal formed between the base 155 and the top 160 to prevent liquid from entering the volume within the base 155. When sealed, a pocket of air may be formed within the volume of the base 155.

In certain forms, the top 160 may be removable from the base 155 (e.g., so that a technician can service the electrical components housed inside). In some forms, the top 160 may be entirely separable from the base 155. In other forms, the top 160 may be remain at least partially connected to the base 155. For example, the top 160 and base 155 can be connected by a hinge, a tether, or a similar connector to that the top 160 remains connected while exposing an interior of the base 155.

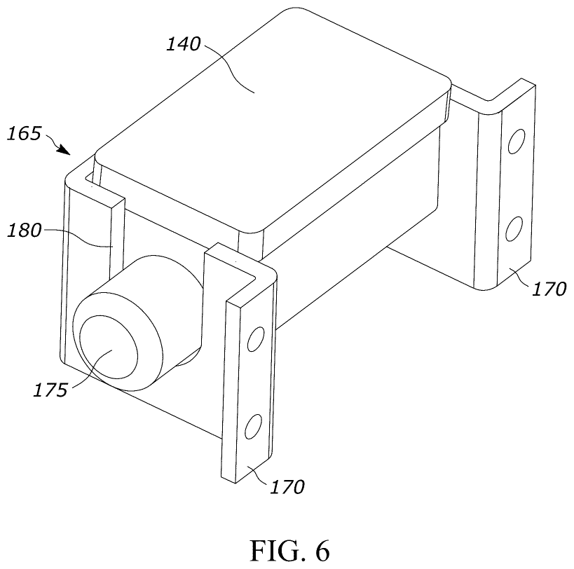

As shown in FIG. 6, the GFCI 140 may be received in a cradle 165. The cradle 165 may include a pair of tabs 170 that may be positioned against a wall of the base 110. As shown in FIG. 3, the cradle 165 may be positioned on an opposite wall of the base 110 from the electrical box 135, although other examples may include the cradle 165 on any other wall. Fasteners may be positioned through the tabs 170 to secure the cradle 165 against the wall of the base 110.

The GFCI 140 may include a pair of ends 175 that may be received through an opening 180 on either end of the cradle 165. The illustrated GFCI 140 may be an in-line GFCI, although other types of GFCIs may be used. The GFCI 140 may be positioned within the cradle 165 so that an end 175 rests within one of the respective openings 180. In other examples, the GFCI 140 may be secured within the cradle 165 to prevent inadvertent removal (e.g., by a fastener, a snap-fit, a frictional engagement, etc.).

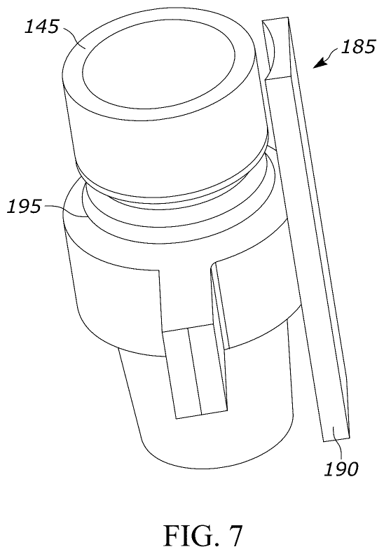

As shown in FIG. 7, a plug 145 may be received within a plug holder 185. The plug holder 185 may include a bracket 190 and an opening 195 that receives the plug holder 185. The bracket 190 may be positioned against a wall of the base 110 and secured to that wall with fasteners. This may be a different wall than the GFCI 140 and/or the electrical box 135 is attached to (see e.g., FIG. 2), although it may be the same wall in another example.

The illustrated plug 145 may be a substantially cylindrical body. In some forms, the plug 145 may be movable relative to the plug holder 185. For example, the plug 145 may rest within the plug holder 185 but may be withdrawn from the plug holder 185 in use (described in more detail below). In other examples, the plug 145 may be fixed relative to the plug holder 185 and within the base 110.

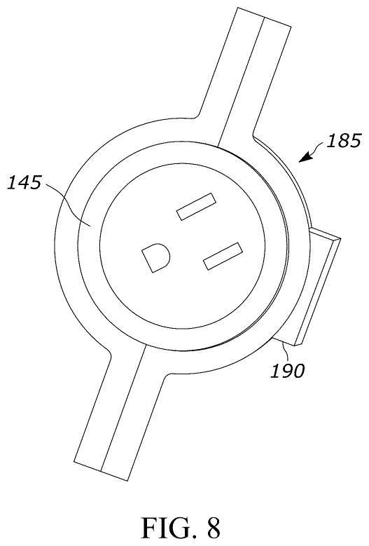

As shown in FIG. 8, the plug 145 may include a female receptacle that can receive the prongs of a male electrical connector. Electrical devices with male electrical connectors may be connected to the plug 145 to provide electrical power.

The enclosure 100 may be an outdoor enclosure that can provide electrical power to users in different environments. For example, the enclosure 100 may be installed in locations that are remote from a structure (e.g., a building) to enable users to receive electrical power while minimizing the use of extension cords and/or portable generators. The enclosure 100 may be buried in the ground in a variety of outdoor locations (e.g., a sidewalk, a roadway, a field, etc.). The material of the enclosure 100 (e.g., polymer concrete) may enable it to support the weight of pedestrian and vehicular traffic.

Because the enclosure 100 is used in an outdoor environment, it is manufactured to be weather resistant. Specifically, the enclosure is designed to prevent water from damaging the electrical components.

In some forms, the lid 115 is not sealed to the base 110. The lid 115 therefore does not entirely prevent the ingress of water into the base 110 and the base 110 may at least partially fill with water during weather events (e.g., rainstorm, flooding, etc.). To prevent damage to the electrical components, they may be water-rated electrical devices (e.g., a shore-rated device). For example, the GFCI 140 and the plug 145 may both be water-rated devices that may be able to continue working after coming in contact with water.

Unlike the enclosure 100, the electrical box 135 may be sealed to prevent the ingress of liquid. For example, the electrical box 135 may receive electrical power from a power source and direct the electrical power toward the electrical plug 145. The volume within the electrical box 135 therefore may be sealed to prevent a failure in the system. A user may not need to routinely access the interior of the electrical box 135 and the seal is less likely to be disturbed.

At least one opening (e.g., two openings-not shown) may be formed within the electrical box 135. A conduit (not shown) may be positioned within each opening. Each conduit may seal the space against the opening to prevent the ingress of liquid into the electrical box 135. The conduits may house electrical conductors that can allow electrical energy to flow from a source into the electrical box 135, and then from the electrical box to the GFCI 140 and then the plug 145.

As described above, sealing the top 160 to the base 155 may create an air pocket within the electrical box 135. This air pocket may provide an internal pressure within the sealed electrical box 135, which may assist in preventing the ingress of liquid.

In use, a user may connect an electrical device to the electrical plug 145 so that the user's device can receive electrical power. Once connected, power from the electrical box 135 may be conveyed to the plug 145 to power the user's device.

In some forms, the lid 115 may be fixed to the base 110 (e.g., via fasteners) and may not be removed to expose the internal volume 120. Instead, the lid 115 may include a door 200, which may be movable relative to the lid 115 to selectively expose the internal volume 120.

As shown in FIGS. 1 and 2, the door 200 may be positioned in the lid 115 proximate to the plug 145. When a user wants to connect to the plug 145, they may at least partially remove the door 200 to expose the internal volume 120. The user may directly connect to the plug 145 while it is supported by the plug holder 185 within the internal volume 120. Alternatively, the length of the conductor between the GCFI 140 and the plug 145 may be greater than the distance between the GCFI 140 and the plug 145 within the base 110. The conductor may act as an extension cord. For example, a user may remove the plug 145 from the holder 185 and pull the plug 145 out of the base 110. The length of the conductor may permit a user to connect to the plug 145 without being directly next to the enclosure 100.

In certain forms, the door 200 may be returned to the closed position when the plug 145 has been removed from the base 110. For example, the conductor may be able to pass through a space between the door 200 and the lid 115 so that ingress into the internal volume 120 of the base 110 is substantially blocked. For example, the lid 115 may remain substantially flat to permit pedestrian and/or vehicular traffic flow.

In some forms (not shown), the plug 145 may include a network connection or a separate plug may include a network connection. This may similarly provide users with a connection point that is remote from a structure.

The electrical devices (e.g., the electrical box 135, the GFCI 140, and the plug 145) may be positioned proximate to an upper end of the outer enclosure 105. In the event that water or other liquid enters the outer enclosure 105, the liquid may travel to the bottom of the base 110 away from the electrical elements. If the water level in the base 110 rises to high toward the electrical devices, the GFCI 140 may trip and cut power from the device inside the electrical box 135 to the plug 145.

In the event that the GFCI 140 is tripped, the user may at least partially remove the door 200 to access and reset the GFCI 140. In this way, the user does not have to remove the entire lid 115 to access the GFCI 140 (or any other component in the volume 120).

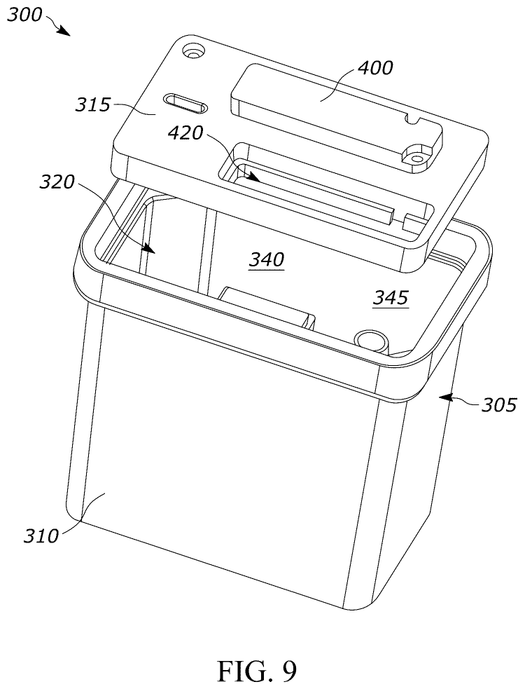

FIGS. 9 to 14 illustrate an alternate example of an enclosure. Only some similarities and differences between enclosure 100 and enclosure 300 may be described. Similar features include the same reference number plus “200”.

As shown in FIG. 9, an enclosure 300 may include an outer enclosure 305. The outer enclosure 305 may include a substantially rectangular shape, although any shape (e.g., a rounded or circular shape) may be used. As described in more detail below, the outer enclosure 305 may be used to support electrical components.

In some forms, the outer enclosure 305 includes a base 310 and a lid 315. The base 310 may include an internal volume 320 that can receive electrical components. The lid 315 may be movable between an open position that at least partially exposes the internal volume 320 and a closed position that at least partially encloses the internal volume. The base 310 and/or lid 315 may be constructed from a similar material as the base 110 and/or lid 115 (e.g., polymer concrete).

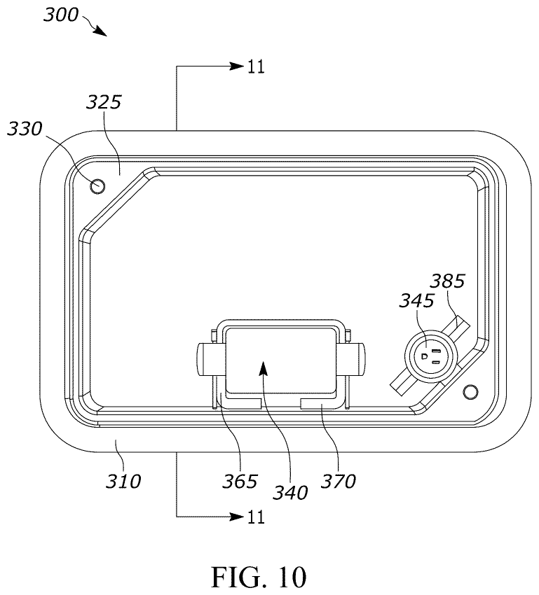

As shown in FIGS. 9 and 10, the base 310 may include an internal lip 325 positioned within the volume 320. The lip 325 may be formed proximate to an upper end of the base 310. For example, the lip 325 may be recessed within the volume 320 a distance that is approximately equal to a thickness of the lid 315.

In certain forms, the corners of the lip 325 with the increased width may include an aperture 330 that may extend through the surface of the lip 325. As described in more detail below, each aperture 330 may receive a fastener for securing the lid 315 to the base 310. The fastener may be a hex bolt (or any similar standard fastener) or the fastener may be a tamper-resistant fastener to limit unauthorized access to the internal volume 320.

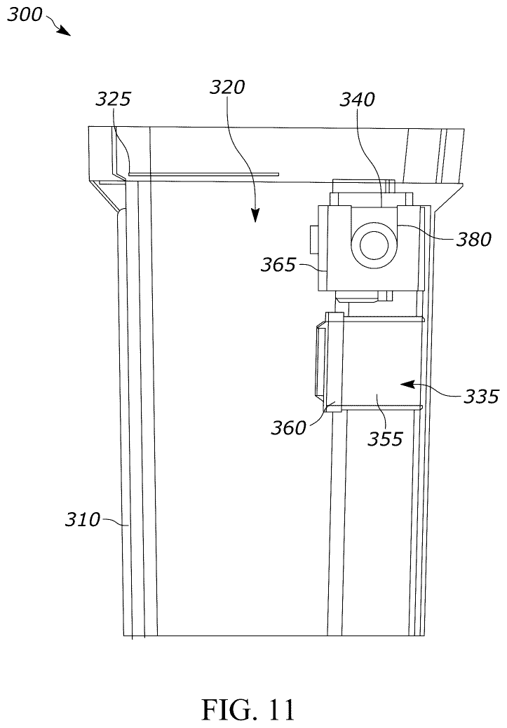

As shown in FIGS. 10 and 11, one or more electrical devices may be received within the internal volume 320 of the base 310. For example, the one or more electrical devices may be secured to a wall of the outer enclosure 305 within the internal volume 320. The illustrated example may include three electrical devices: an electrical box 335, a ground-fault circuit interrupter (GFCI) 340, and a plug 345. Although other examples may include a different number of electrical devices.

In the illustrated example, the electrical box 335 and the GCFI 340 may be secured to the same wall of the outer enclosure 305. For example, the GFCI 340 may be received in the cradle 365 that is positioned toward an upper end of the outer enclosure 305 proximate to the lip 325, and the electrical box 335 may be positioned below the GFCI 340 (e.g., in the orientation of FIG. 11). This orientation may permit user access to the GFCI 340 (e.g., if the GFCI trips) and may also minimize obstructions when removing the top 360 from the base 355 of the electrical box 335. When connected, the top 360 and base 355 may form a seal to prevent the ingress of liquid.

In some forms, the tabs 370 extend from the cradle 365 toward one another. This may minimize the footprint of the GFCI 340 within the enclosure 300.

With continued reference to FIG. 10, the plug 345 may be received within a plug holder 385, which may be positioned against a wall of the outer enclosure 305 and secured to that wall with fasteners. This may be a different wall than the GFCI 340 and/or the electrical box 335 is attached to, although it may be the same wall in another example.

The illustrated plug 345 may be a substantially cylindrical body. In some forms, the plug 345 may be movable relative to the plug holder 385. For example, the plug 345 may rest within the plug holder 385 but may be withdrawn from the plug holder 185 in use (described in more detail below). In other examples, the plug 345 may be fixed relative to the plug holder 385 and within the base 310. An electrical conductor (e.g., a cable-not shown) may extend between the GFCI 340 and the plug 345. The width of the cable may be less than the width of the plug 345.

The enclosure 300 may be an outdoor enclosure that can provide electrical power to users in different environments. The material of the enclosure 300 (e.g., polymer concrete) may enable it to support the weight of pedestrian and vehicular traffic. Because the enclosure 300 is used in an outdoor environment, it is manufactured to be weather resistant. Specifically, the enclosure is designed to prevent water from damaging the electrical components.

The lid 315 does not entirely prevent the ingress of water into the base 310 and the base 310 may at least partially fill with water during weather events (e.g., rainstorm, flooding, etc.). To prevent damage to the electrical components, they may be water-rated electrical devices (e.g., a shore-rated device). For example, the GFCI 340 and the plug 345 may both be water-rated devices that may be able to continue working after coming in contact with water.

In use, a user may connect an electrical device to the electrical plug 345 so that the user's device can receive electrical power. Once connected, power from the electrical box 335 may be conveyed to the plug 345 to power the user's device.

In some forms, the lid 315 may be fixed to the base 310 (e.g., via fasteners) and may not be removed to expose the internal volume 320. Instead, the lid 315 may include a door 400, which may be movable relative to the lid 315 to selectively expose the internal volume 320.

In certain forms, the door 400 may include a door fastener opening 405 that can receive a fastener to selective secure the door 400 in a closed position. The door fastener opening 405 may be aligned with a lid fastener opening 410 and the aperture 330 on the lip 325. A single fastener may be inserted through all three openings to secure the door 400 and the lid 315 together to the base 310. In other examples, a separate fastener may be used to connected the lid 315 to the base 310 and the door 400 to the lid 315.

In one form, the door 400 may include a top surface 415. The door fastener opening 405 may be disposed in a different surface that is recessed relative to the top surface 415. This may permit the head of the fastener to be positioned below the top surface 415 to maintain a low-profile appearance.

As shown in FIG. 11, the door 400 may be positioned in the lid 315 proximate to the plug 345. When a user wants to connect to the plug 345, they may at least partially remove the door 400 to expose the internal volume 320. The user may directly connect to the plug 345 while it is supported by the plug holder 385 within the internal volume 320. Alternatively, the length of the conductor between the GCFI 340 and the plug 345 may be greater than the distance between the GCFI 340 and the plug 345 within the base 310. The conductor may act as an extension cord. For example, a user may remove the plug 345 from the holder 385 and pull the plug 345 out of the base 310. The length of the conductor may permit a user to connect to the plug 345 without being directly next to the enclosure 300.

In one form, the user may entirely remove the door 400 from the lid 315. The plug 345 may be accessed by the connection opening 420 exposed by removing the door (e.g., either by removing the plug 345 through the opening 420 or inserting an external device into the opening 420).

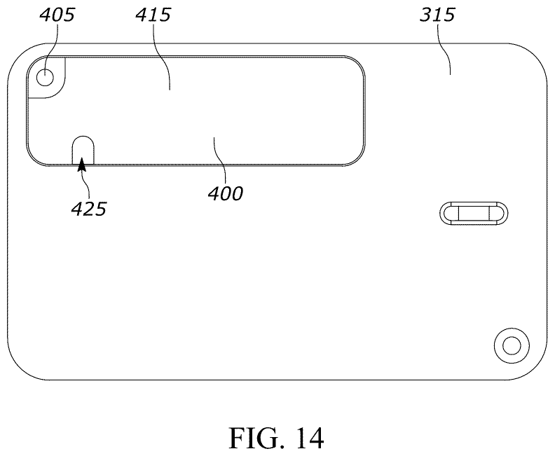

In one form, the plug 345 may be removed from the internal volume 320 and the door 400 may return to the closed position (see e.g., FIG. 14). The door 400 may include a cutout 425 that passes entirely through the door 400 and provides communication with the internal volume 320. The width of the cable (e.g., extending between the GFCI 340 and the plug 345) may be approximately the width of the cutout 425. Therefore, the cable may fit within the cutout after the plug 345 has been withdrawn and the door 400 can return to the close position. This may help protect the components within the internal volume 320 while still providing access to electrical power. When power is no longer needed, the door 400 may be removed so that the plug 345 can return to the plug holder 385.

In one form, the door 400 may be connected to the lid 315 so that even when the door 400 is removed to expose the internal volume 320, it may remain connected to the lid 315 (e.g., to limit misplacing the door 400). The connection may be a hinge, a tether, or any similar connection.

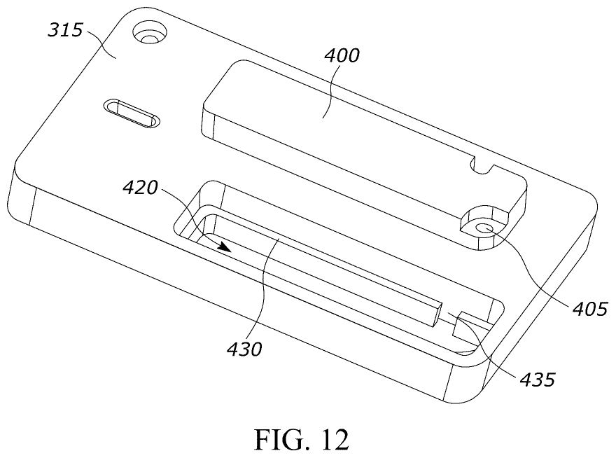

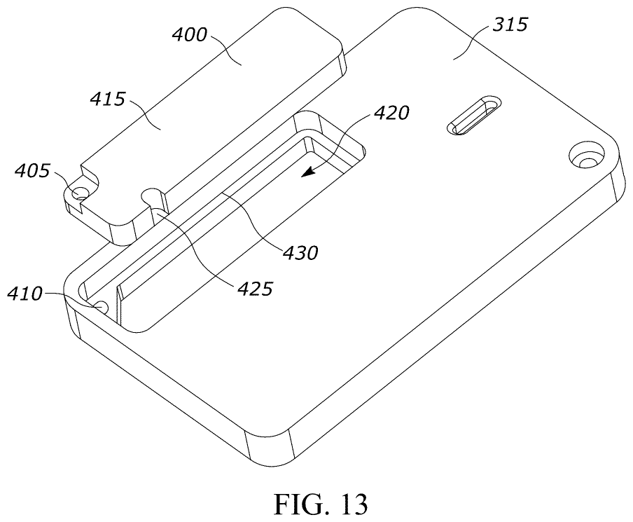

With continued reference to FIGS. 12 and 13, the lid 315 may include a lid lip 430 that is recessed from the top surface 415 and forms at least a portion of an inner perimeter of the opening 420. The lip 430 may support the door 400 in the closed position. For example, the door 400 may contact the lid lip 430 to be secured by the fastener.

In some forms, the lid lip 430 may extend around only a portion of the perimeter of the opening 420. For example, the lid lip 430 may include a discontinuity 435, which may be approximately the width of the cable and may be aligned with the cutout 425. The cable may pass through the cutout 425 and the discontinuity 435 so that the plug 345 can be exposed while the lid is in the closed position.

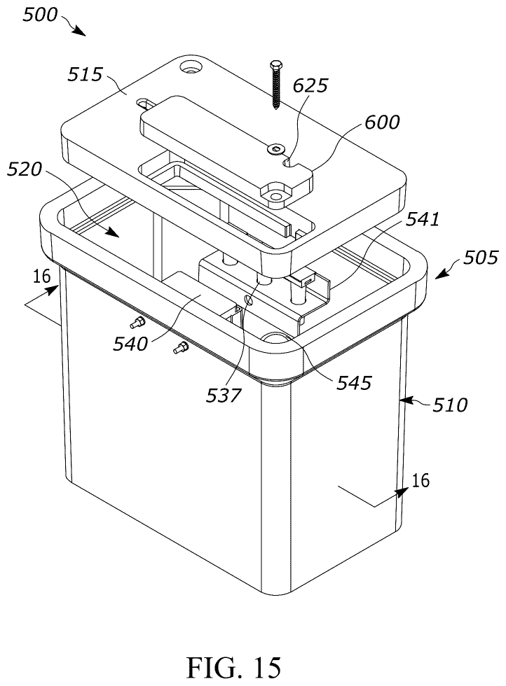

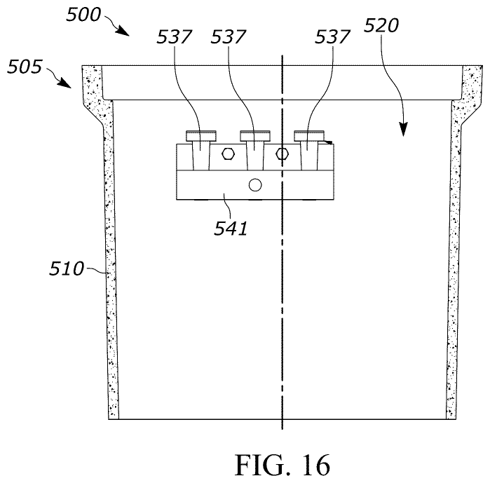

FIGS. 15 and 16 illustrate an enclosure 500, which may be similar to the enclosure 100. Only some similarities between the enclosures 100, 500 may be described. Similar features include the same reference number plus “400”.

As shown in FIG. 15, an enclosure 500 may include an outer enclosure 505. The outer enclosure 505 may include a substantially rectangular shape, although any shape (e.g., a rounded or circular shape) may be used.

In some forms, the outer enclosure 505 includes a base 510 and a lid 515. The base 510 may include an internal volume 520 that can receive electrical components. The lid 515 may be movable between an open position that at least partially exposes the internal volume 520 and a closed position that at least partially encloses the internal volume. The base 510 and/or the lid 515 may be constructed from a rigid material similar to the material used in the enclosure 100.

One or more electrical devices may be received within the internal volume 520 of the base 510. For example, the one or more electrical devices may be secured to a wall of the base 510 within the internal volume 520. The illustrated example may include three electrical devices: an electrical splice 537, a ground-fault circuit interrupter (GFCI) 540, and a plug 545. Although other examples may include a different number of electrical devices.

In some forms, a holder 541 may be mounted to an inner surface of the base 510 within the internal volume 520. As shown in FIG. 15, the holder 541 may be mounted on a wall in a similar position as the electrical box 135. The illustrated holder 541 includes one or more openings (e.g., three shown) that can receive the electrical splice 537.

As shown in FIG. 16, each electrical splice 537 may be at least partially inserted through one of the openings in the holder 541. In the illustrated example, the electrical splice 537 may have a conical or frusto-conical shape. One end may have a width that is less than a width of the opening and the other end may have a width that is greater than the width of the opening. This may permit the electrical splice 537 to be received partially through the respective opening, but not slide all the way through the opening once inserted.

In some forms, each electrical splice 537 may include an internal passage. A grease or lubricant may be applied to an internal surface of each electrical splice 537, which may assist conductors in entering the internal passage. For example, two conductors may be inserted into the internal passage and electrically connected. One electrical conductor my provide electrical power to the enclosure 500 from a power source and the other electrical conductor may connect to the GFCI 540. The electrical splice 537 may be enclosed (e.g., with a sealable cover or watertight washer) to limit the ingress of liquid.

In some forms, each electrical splice 537 may be separably removable from the holder 541. This may permit a technician to inspect, adjust, and/or service a specific electrical connection without disturbing other electrical connections.

Returning to FIG. 15, the lid 515 may include a door 600, which may be movable relative to the lid 515 to selectively expose the internal volume 520. The door 600 may be positioned in the lid 515 proximate to the plug 545. When a user wants to connect to the plug 545, they may at least partially remove the door 600 to expose the internal volume 520. The user may directly connect to the plug 545 while it is supported within the internal volume 520 (e.g., by the plug holder not shown). Alternatively, the length of the conductor between the GCFI 540 and the plug 545 may be greater than the distance between the GCFI 540 and the plug 545 within the base 510. The conductor may act as an extension cord. For example, a user may pull the plug 545 out of the base 510. The length of the conductor may permit a user to connect to the plug 545 without being directly next to the enclosure 500.

In certain forms, the door 600 may be returned to the closed position when the plug 545 has been removed from the base 510. For example, the conductor may be able to pass through a space between the door 600 and the lid 515 (e.g., a cutout 625) so that ingress into the internal volume 520 of the base 510 is substantially blocked. For example, the lid 515 may remain substantially flat to permit pedestrian and/or vehicular traffic flow.

As with the enclosure 100, the lid 515 of the enclosure 500 may not be sealed (e.g., in a liquid-tight arrangement) to the base 510, and therefore liquid may enter the interior volume 520 during normal use. The electrical splice 537 may provide a substantially liquid-tight enclosure to protect the electrical conductors housed within. Additionally, the holder 541 may be positioned away from the bottom of the base 510 so that any liquid pooling within the internal volume 520 may not rise to the height of the holder 541.

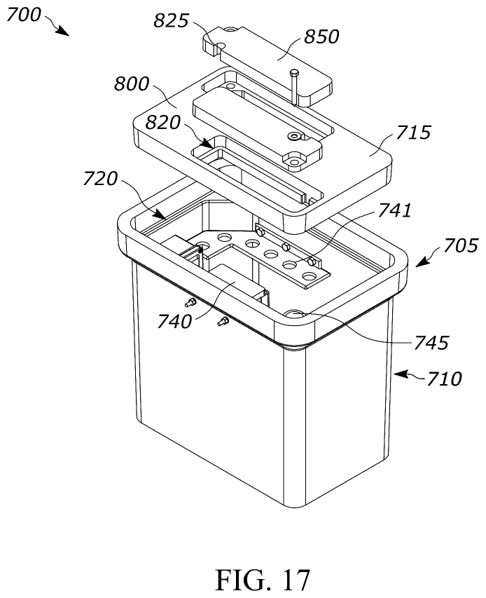

FIGS. 17 to 19 illustrate an alternate example of the enclosure 500. Only some similarities and differences between enclosure 700 and the enclosure 500 may be described. Similar features may include the same reference number, plus “200”.

In some forms, the enclosure 700 includes an outer enclosure 705 with a base 710 and a lid 715. The base 710 may include an internal volume 720 that can receive electrical components. The lid 715 may be movable between an open position that at least partially exposes the internal volume 720 and a closed position that at least partially encloses the internal volume. The base 710 and/or the lid 715 may be constructed from a rigid material similar to the material used in the enclosure 500.

One or more electrical devices may be received within the internal volume 720 of the base 710. For example, the one or more electrical devices may be secured to a wall of the base 710 within the internal volume 720. The illustrated example may include a ground-fault circuit interrupter (GFCI) 740 and a plug 745. Although other examples may include a different number of electrical devices.

In some forms, a holder 741 may be mounted to an inner surface of the base 710 within the internal volume 720. As shown in FIG. 17, the holder 741 may be mounted on a wall in a similar position as the electrical box 135. The illustrated holder 741 includes one or more openings (e.g., six shown) that can receive the electrical splice 537.

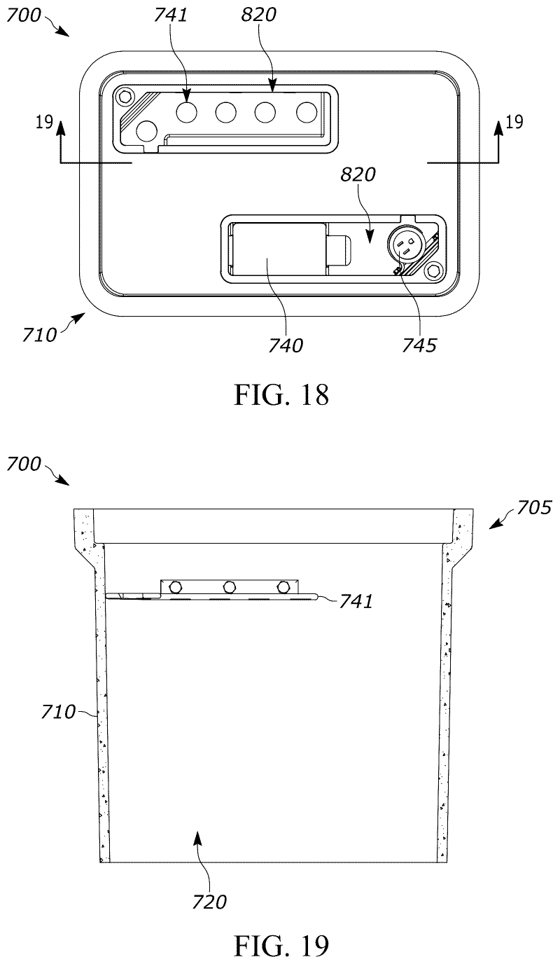

As shown in FIGS. 17 and 18, the holder 741 may be larger than the holder 541. Specifically, the holder 741 may be angled (e.g., L-shaped) and extend against and/or connect to multiple walls of the base 710. Openings in the holder 741 may be similarly sized to the openings in the holder 541 so that the electrical splices 537 may be inserted into either.

With continued reference to FIGS. 17 and 18, the lid 715 may include two openings 820 and a door may be removably positionable in each opening 820 to selectively limit access to the internal volume 720. The two openings 820 may be disposed along opposite sides of the lid 715. The first door 800 may be similar to the above-described doors (e.g., door 600) and may selectively provide access to the plug 745. The second door 850 may be selectively positioned in the other opening 820. In the illustrated example, both doors 800, 850 may be structurally similar and may connect to the lid 715.

In certain forms, a technician may remove the door 850 to inspect the electrical splices 537 housed in the holder 741. The technician may be able to adjust or replace the connections within the splice 537 without removing the entire lid 715.

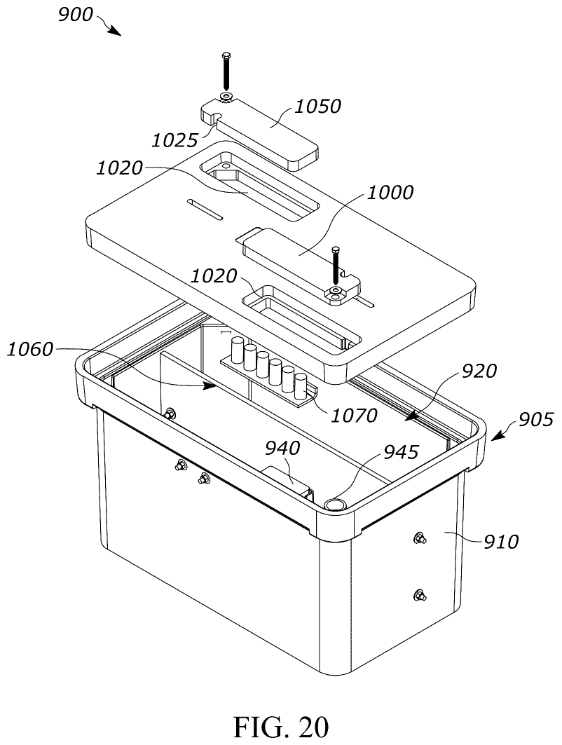

FIGS. 20 to 23 illustrate an alternate example of the enclosure 500. Only some similarities and differences between enclosure 900 and the enclosure 500 may be described. Similar features may include the same reference number, plus “400”.

In some forms, the enclosure 900 includes an outer enclosure 905 with a base 910 and a lid 915. The base 910 may include an internal volume 920 that can receive electrical components. The lid 915 may be movable between an open position that at least partially exposes the internal volume 920 and a closed position that at least partially encloses the internal volume. The base 910 and/or the lid 915 may be constructed from a rigid material similar to the material used in the enclosure 500.

One or more electrical devices may be received within the internal volume 920 of the base 910. For example, the one or more electrical devices may be secured to a wall of the base 910 within the internal volume 920. The illustrated example may include a ground-fault circuit interrupter (GFCI) 940 and a plug 945. Although other examples may include a different number of electrical devices.

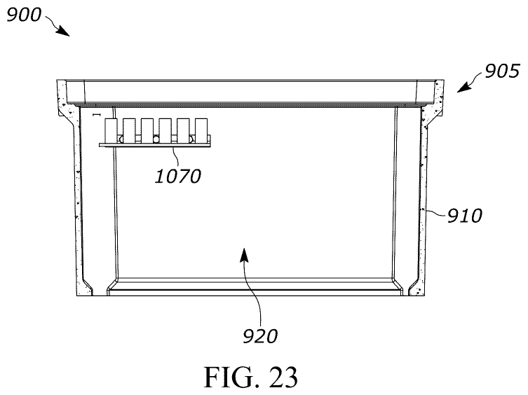

In some forms, a holder 941 may be mounted to an inner surface of the base 910 within the internal volume 920. As shown in FIG. 23, the holder 941 may be mounted on the same wall as the GFCI 940. The illustrated holder 941 includes one or more openings (e.g., six shown) that can receive the electrical splice 937.

Returning to FIG. 20, a divider wall 1060 may extend across the base 910 and divide the internal volume 920 in two. For example, the divider wall 1060 may extend substantially along a center of the base 910 and divide the internal volume 920 in two. In some forms, the divider wall 1060 may be integrally formed with the remainder of the base 910 (e.g., constructed from the same material). In other examples, the divider wall 1060 may be removable to permit a technician to selectively determine whether the interior volume is divided.

In some forms, a connector 1070 (e.g., an electrical connector) may be disposed in the internal volume 920 of the base on the opposite side of the wall 1060 from the holder 941. The connector 1070 may be different than the plug 945. In the illustrated example, the connector 1070 may be a network connector (e.g., ethernet) for providing connection to the internet, although other types of electrical connections may be used. The illustrated example may include multiple connectors 1070 arranged together (e.g., in a row). The divider wall 1060 may divide the interior volume 920 so that different electrical outputs (e.g., lower and higher voltage outputs) are separated on different sides of the divider wall 1060.

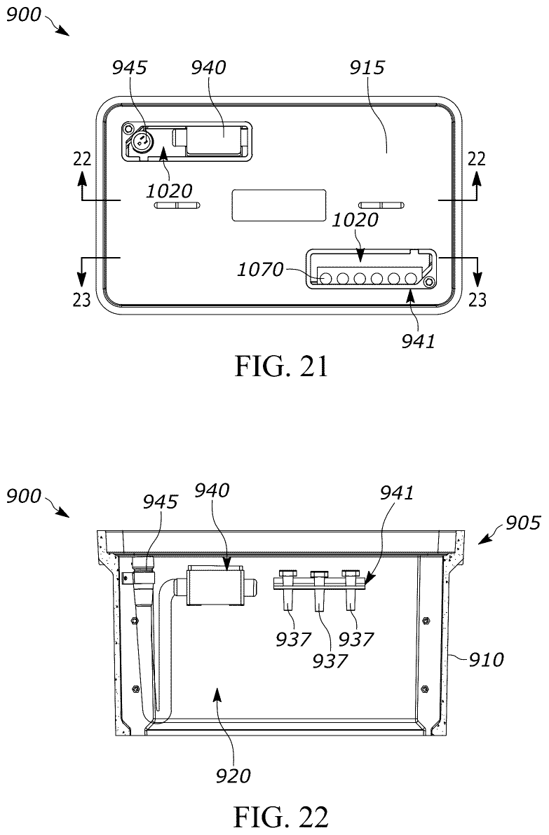

As shown in FIGS. 20 and 21, a first door 1000 and a second door 1050 may be removably coupled to the lid 915. The doors 1000, 1050 may be disposed in the lid 915 so that when the lid 915 is connected to the base 910, the doors 1000, 1050 may be disposed on opposite sides of the divider wall 1060. A technician may selectively remove the doors 1000, 1050 to access the plug 945 and/or the connector 1070. Both doors 1000, 1050 may include a cutout 1025, which can provide access to the respective one of the plug 945 and the connector 1070 when the respective door 1000, 1050 is coupled to the lid 915.

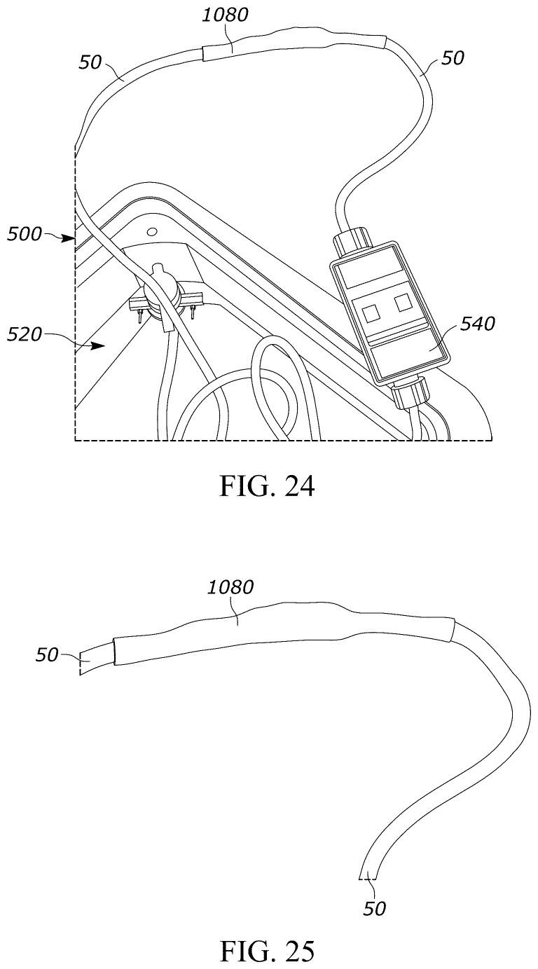

In some examples, the electrical splices (e.g. splice 537) in any of the above-described examples may be replaced with a heat-shrinking material 1080. As shown in FIGS. 24 and 25, electrical conductors 50 may be positioned within the sleeve of material 1080 and spliced together. In some forms, the electrical conductors 50 may be inserted into an inner retainer and connected by tightening a fastener (e.g., a threaded screw). The outer sleeve of material 1080 may shrink or tighten (e.g., with the application of heat) around the electrical conductors 50 and the inner retainer to further assist in retaining the splice. The material of the outer sleeve 1080 may then be sealed around the now spliced conductors. The material may be liquid resistant and may similarly block liquid from reaching the exposed portion of the conductors.

In some forms, the splices formed with the shrinking material may be disposed within the internal volume of the respective enclosure. In other examples, the electrical conductors with the shrinking material may be disposed in a holder (e.g., holder 541).

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various examples of the disclosure. Once armed with the present specification, routine experimentation is all that is needed to determine adjustments and modifications that will carry out the present disclosure.

The above examples are for illustrative purposes and are not intended to limit the scope of the disclosure or the adaptation of the features described herein. Those skilled in the art will also appreciate that various adaptations and modifications of the above-described preferred examples can be configured without departing from the scope and spirit of the disclosure. Therefore, it is to be understood that, within the scope of the appended claims, the disclosure may be practiced other than as specifically described.

What is claimed is:

1. An enclosure system comprising:
an underground enclosure including,
a base having a first wall that at least partially defines an internal volume, wherein the wall includes a lip that extends into the internal volume, and
a lid coupled to the base to at least partially enclose the volume, the lid configured to contact the lip and be received at least partially within the internal volume;
a ground-fault circuit interrupter (GFCI) disposed within the base, wherein the GFCI is configured to receive electrical power; and
an electrical outlet in electrical communication with the GFCI, wherein the electrical outlet is positioned downstream from the GFCI, and wherein the electrical outlet is configured to connect to an external electrical device and provide power to the external electrical device.

2. The enclosure system of claim 1, wherein the underground enclosure is constructed from a first material that is a polymer concrete.

3. The enclosure system of claim 1, wherein a first conduit is connected to the electrical enclosure in a sealing engagement and configured to convey an electrical conductor out of the electrical enclosure and toward the second electrical device.

4. The enclosure system of claim 1, further comprising an electrical enclosure housing a first electrical device that is configured to receive electrical power from a source and transmit power to the GFCI, wherein the first electrical device is sealed and configured to prevent the ingress of liquid from the internal volume.

5. The enclosure system of claim 1, wherein the lid includes a first thickness and the lip is disposed a first distance from an upper end of the wall, and wherein the first thickness is equal to the first distance.

6. The enclosure system of claim 1, wherein the lid includes a body and a door that is movable relative to the body, wherein the door is configured to move from a closed position to an open position to expose the internal volume while the lid remains fixed to the base.

7. The enclosure system of claim 1, wherein the GFCI is an in-line GFCI.

8.-23. (canceled)

24. An underground enclosure system comprising:
an underground enclosure including a base having a first wall that at least partially defines an internal volume;
a first electrical device that is configured to receive electrical power from a source, wherein the first electrical device is spliced to an electrical conductor and sealed within a material that is configured to prevent the ingress of liquid from the internal volume;
a second electrical device in electrical communication with the first electrical device, wherein the second electrical device is configured to connect to an external electrical device and provide power to the external electrical device; and
a ground-fault circuit interrupter (GFCI) disposed within the base and electrically connected between the first electrical device and the second electrical device.

25. The underground enclosure system of claim 24, wherein the second electrical device is removably received within a holder and is configured to be removed from the base while remaining electrically connected to the first electrical device.

26. The underground enclosure system of claim 24, wherein the second electrical device is a shore-rated device and is configured to continue to provide power to the external electrical device contacting liquid.

27. The underground enclosure system of claim 24, wherein the underground enclosure is constructed from a first material that is configured to support a vehicular load.

28. The underground enclosure system of claim 24, wherein the underground enclosure further includes a lid removably connected to the base to at least partially enclose the internal volume.

29. The underground enclosure system of claim 28, wherein the lid further includes a body and a door that is movable relative to the body, the lid connected to the base so that the door is proximate to the second electrical device and/or the GFCI, and wherein the door is configured to move relative to the body to expose the second electrical device and/or the GFCI.

30. The underground enclosure of claim 24, wherein the material is heat shrunk around the electrical conductor.

31. The underground enclosure of claim 24, wherein a divider wall separates the internal volume into a first section and a second section, wherein the second electrical device and the GFCI are disposed in the first section, and wherein a third electrical device is disposed in the second section, the third electrical device is configured to connect to a second external electrical device and provide power to the second external electrical device.

32. A method of installing an underground enclosure system, the method comprising:
installing an enclosure having an interior volume at least partially underground;
feeding a first electrical conductor into the interior volume, wherein the first electrical conductor is configured to provide electrical energy from a source;
splicing a second electrical conductor to the first electrical conductor by heat-shrinking material around the splice, wherein the second electrical conductor is connected to a ground-fault circuit interrupter (GFCI) disposed within the interior volume; and
connecting a lid to the enclosure to at least partially cover the interior volume.

33. The method of claim 32, wherein the underground enclosure is constructed from a first material that is configured to support a vehicular load.

34. The method of claim 32, wherein the lid further includes a body and a door that is movable relative to the body, the method further comprising moving the door relative to the lid while the lid remains coupled to the enclosure.

35. The method of claim 32, wherein the GFCI is an in-line GFCI.

36. The method of claim 32, wherein the lid further includes a body and a door that is movable relative to the body, the lid connected to the base so that the door is proximate to the second electrical device and/or the GFCI, the method further comprising moving the door relative to the body to expose the second electrical device and/or the GFCI
